(19) United States
(12) Patent Application Publication
(10) Pub. No.: US 2025/0013653 A1
(43) Pub. Date: Jan. 9, 2025

(54) FEDERATED QUERY PROCESSING FOR DISTRIBUTED DATABASES

(71) Applicant: VMware, Inc., Palo Alto, CA (US)

(72) Inventors: Xiaoliang Li, Beijing (CN); Wen Lin, Beijing (CN); Huiliang Liu, Beijing (CN); Mulong Chen, Beijing (CN); Xiaoran Wang, Beijing (CN); Xuejing Zhao, Beijing (CN); Jian Guo, Beijing (CN)

(21) Appl. No.: 18/243,628

(22) Filed: Sep. 7, 2023

(30) Foreign Application Priority Data
Jul. 7, 2023 (WO) PCT/CN2023/106234

(51) Int. Cl. G06F 16/248; G06F 16/22; G06F 16/2453; G06F 16/28

(52) U.S. Cl. CPC G06F 16/248; G06F 16/2282; G06F 16/24532; G06F 16/285

(57) ABSTRACT

The disclosure provides a method for querying data across a plurality of distributed databases. The method includes receiving a query at a local coordinator of a local database cluster. The method further includes sending the query to a remote coordinator of a remote database cluster. The method further includes retrieving, by each local segment of a plurality of local segments of the local database cluster, data responsive to the query from corresponding one or more remote segments of the remote database cluster associated with the local segment. The method further includes sending a response to the query based on the data responsive to the query from each of the corresponding one or more remote segments.

### CLAIM OF PRIORITY

This application claims priority to International Application Number PCT/CN2023/106234, entitled “Federated Query Processing for Distributed Databases”, filed on Jul. 7, 2023. The disclosure of this application is hereby incorporated by reference.

Often times, an entity, such as an enterprise, may have data stored in multiple different databases. Further, the entity may need to run queries across the multiple databases. A query may be, for example, a SQL statement or other command requesting data that matches one or more characteristics identified in the query from the multiple databases. Systems that allow for queries to be run across multiple databases are commonly referred to as federated query processing systems.

However, conventional federated query processing systems are not capable of efficiently performing federated queries across certain databases, such as distributed, massively parallel processing, hybrid transaction/analytical processing databases, such as GREENPLUM® DATABASE (Greenplum is a trademark of VMware, Inc. in the U.S. and other countries). In particular, the distributed nature of certain databases makes performing federated queries across multiple distributed databases challenging.

Accordingly, there is a need for a federated query processing system that works with such distributed databases.

### SUMMARY

One or more embodiments provide a method for querying data across a plurality of distributed databases. The method includes receiving a query at a local coordinator of a local database cluster. The method further includes sending the query to a remote coordinator of a remote database cluster. The method further includes retrieving, by each local segment of a plurality of local segments of the local database cluster, data responsive to the query from corresponding one or more remote segments of the remote database cluster associated with the local segment. The method further includes sending a response to the query based on the data responsive to the query from each of the corresponding one or more remote segments.

Further embodiments include one or more non-transitory computer-readable media comprising instructions that, when executed by one or more processors of a computer system, cause the computer system to carry out the above method(s). Further embodiments include a computer system comprising at least one memory and one or more processors configured to carry out the above method(s).

### BRIEF DESCRIPTION OF THE DRAWINGS

FIG. 1 illustrates a computing system in which embodiments described herein may be implemented.

FIG. 2 illustrates a block diagram depicting an instance of a distributed database.

FIG. 3 shows a flow diagram depicting a method for querying data from an instance of a distributed database.

FIG. 4 illustrates a block diagram depicting a federated query processing system for querying data across a plurality of distributed databases.

FIG. 5 shows a call flow diagram depicting a method for operating the federated query processing system of FIG. 4.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques for implementing a federated query processing system for distributed databases are discussed herein. Certain embodiments provide mechanisms (e.g., a parallel retrieve cursor) to execute a query in parallel on different portions (e.g., segments) of a remote database cluster and retrieve results of the query in parallel by different portions (e.g., segments) of a local database cluster. Accordingly, the processing of the query and retrieval of data responsive to the query is parallelized, instead of being performed via a single bottleneck (e.g., a single coordinator of the local database cluster). Thus, latency for processing the query and retrieving data responsive to the query is reduced, providing a beneficial technical effect.

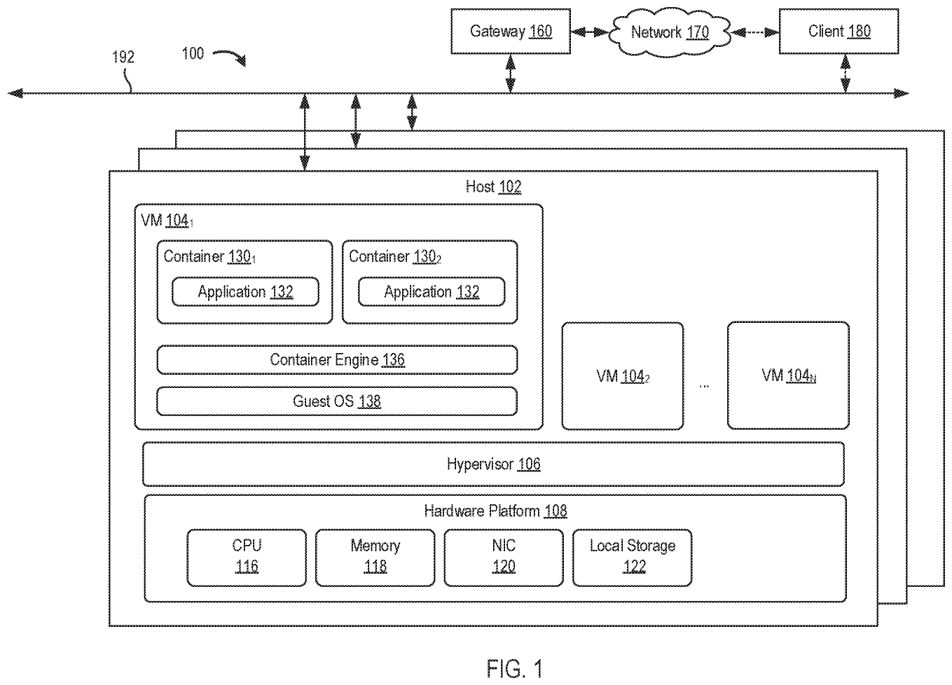

FIG. 1 is a block diagram that illustrates a computing system 100 in which embodiments described herein may be implemented. Computing system 100 includes one or more hosts 102 connected by a physical network 192. In particular, physical network 192 enables communication between hosts 102, and/or between other components and hosts 102. Though not shown, connections between components and hosts 102 may be via one or more additional networks and/or components. Computing system 100 may be a data center.

Hosts 102 may be in a single host cluster or logically divided into a plurality of host clusters. A host cluster refers to a number of hosts, which may be managed together. In some embodiments, a host 102 may be configured to provide a virtualization layer, also referred to as a hypervisor 106, that abstracts processor, memory, storage, and networking resources of a hardware platform 108 of host 102 into multiple VMs 1041 to 104N (collectively referred to as VMs 104 and individually referred to as VM 104) that run concurrently on the same host 102. In certain aspects, a host 102 and/or VM 104 may be configured to run one or more other virtual computing instances (VCIs), such as containers. In certain aspects, host 102 does not include a hypervisor 106. In certain aspects, host 102 runs an operating system (OS).

Hardware platform 108 of each host 102 includes components of a computing device such as one or more processors (central processing units (CPUs)) 116, memory 118, a network interface card including one or more network adapters, also referred to as NICs 120, and/or storage 122. CPU 116 is configured to execute instructions that may be stored in memory 118 and, optionally, in storage 122.

In certain embodiments, computing system 100 further includes a gateway 160 coupled to network 192. Gateway 160 provides hosts 102 and other components in computing system 100 with connectivity to external networks, such as network 170 (e.g., the Internet), and is used to communicate with destinations external to computing system 100. In certain aspects, a client device 180 (e.g., similar to host 102, or a VCI), is external to computer system 100 and communicates with components of computer system 100 via network 170 and gateway 160. In certain aspects, client device 180 may directly connect to network 192, such as where the client device is internal to computing system 100.

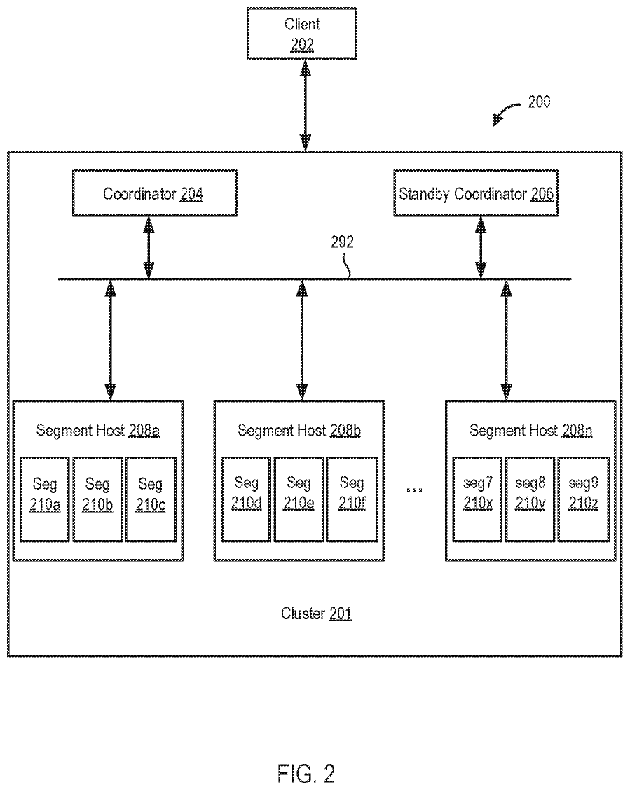

FIG. 2 illustrates a block diagram depicting an instance of a distributed database 200. Distributed database 200 runs on a database cluster 201. Database cluster 201 includes a coordinator 204, which may be a physical computing device (e.g., host 102 of FIG. 1) or a VCI (e.g., running on a host 102 of FIG. 1). Database cluster 201 further includes a standby coordinator 206, which may be a physical computing device (e.g., host 102 of FIG. 1) or a VCI (e.g., running on a host 102 of FIG. 1).

Database cluster 201 further includes segment hosts 208a-208n (collectively referred to as segments hosts 208 and individually as segment host 208), each of which may be a physical computing device (e.g., host 102 of FIG. 1) or a VCI (e.g., running on a host 102 of FIG. 1). The coordinator 204, standby coordinator 206, and segment hosts 208 communicate via network 292 (e.g., network 192 of FIG. 1). A client 202 (e.g., client 180 of FIG. 1) communicates with components of the database cluster 201, such as via network 292, or via a gateway and an external network (not shown).

Coordinator 204 is configured to receive queries for data stored on segment hosts 208, and further communicate with segment hosts 208 to receive data responsive to the queries. For example, coordinator 204 may receive queries from client 202 and/or other devices. In certain aspects, a query may be structured as a SQL statement.

Standby coordinator 206 is configured to perform the same functions as coordinator 204 and operate as a backup coordinator to coordinator 204. For example, should coordinator 204 become unavailable, queries can instead be directed to and handled by standby coordinator 206. For example, the standby coordinator 206 may be promoted to the active coordinator and receive queries, e.g., SQL statements, from client 202. Though one standby coordinator 206 is shown, in certain embodiments, there may be any number of standby coordinators or no standby coordinator.

Each segment host 208 is configured to run one or more segments 210. A segment 210 may be a computing node, such as a process or VCI, configured to manage and store a portion of data of the distributed database 200. For example, a segment 210 may have a portion of storage of a corresponding segment host 208 allocated to segment 210. For example, each segment 210 may store a different portion of data of the distributed database 200 on the segment host 208 on which the segment 210 runs. As shown, segments 210a-210z (collectively referred to as segments 210 and individually as segment 210) run on segment hosts 208. Though each segment host 208 is shown as including three segments 210, any number of segments 210 may run on each segment host 208, and different segments hosts 208 may run a different number of segments 210.

In certain aspects, coordinator 204 stores metadata about distributed database 200, including metadata indicating where data is stored in distributed database 200, such as in which segment 210, on which segment host 208, and/or the like. For example, the metadata may including metadata about distributed database 200, a schema of distributed database 200, database tables, database columns, and/or the like. Accordingly, when coordinator 204 receives a query from client 202, coordinator 204 can determine which segments 210 may store data responsive to the query based on the metadata, and which segment hosts 208 the segments 210 are running on.

In certain aspects, coordinator 204 runs a process called a query dispatcher (not shown) configured to dispatch the query received from client 202 to the segments 210 that may store data responsive to the query. In certain aspects, each segment 210 runs a process called a query executor (not shown) that executes the query on the data stored by the segment 210 to retrieve data responsive to the query.

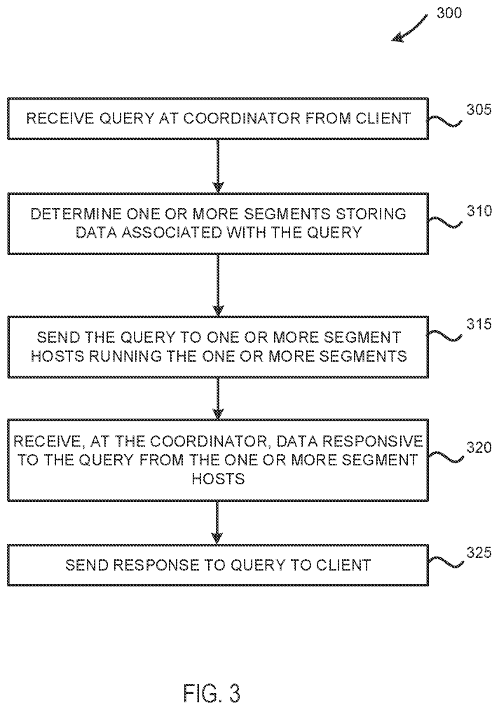

FIG. 3 illustrates a flow diagram depicting a method 300 for querying data from an instance of a distributed database, in accordance with some embodiments.

At 305, coordinator 204 receives a query from client 202. At 310, the coordinator 204 determines one or more segments 210 that store data associated with the query, such as using the metadata about distributed database 200. At 315, the coordinator 204 sends the query to one or more segment hosts 208 running the one or more segments 210 determined to store data associated with the query. Each of the one or more segments 210 runs the query and retrieves data responsive to the query, such as using known database techniques. At 320, the coordinator 204 receives data responsive to the query from each of the one or more segment hosts 208. At 325, coordinator 204 sends a response to the query to client 202, such as a response including the data received at 320.

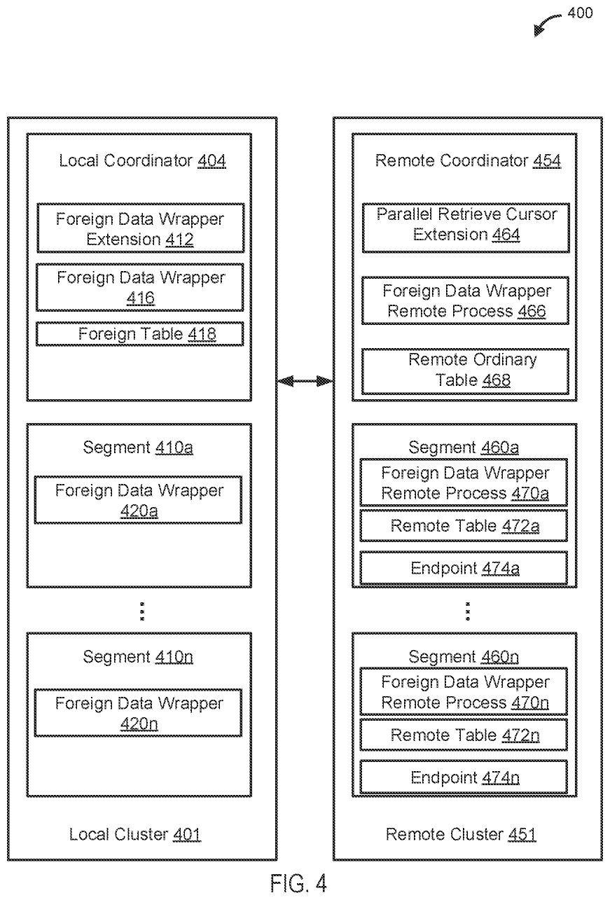

FIG. 4 illustrates a block diagram depicting a federated query processing system 400 for querying data across a plurality of distributed databases.

As shown, system 400 includes a local database cluster 401 (e.g., an instance of database cluster 201 of FIG. 2). System 400 further includes a remote database cluster 451 (e.g., an instance of database cluster 201 of FIG. 2). The local database cluster 401 may correspond to a local database instance where the query from a client is received. The remote database cluster 451 may correspond to a remote database instance that also needs to be queried based on the query from the client. Though only one remote database cluster 451 is shown, there may be additional remote database clusters that local database cluster 401 similarly communicates with to query. In certain aspects, local database cluster 401 and remote database cluster 451 are coupled to a network (e.g., network 170 of FIG. 1), and communicate via the network (e.g., via gateways, such as gateway 160 of FIG. 1).

The local cluster 401 includes local coordinator 404 (e.g., an instance of coordinator 204 of FIG. 2) and segments 410a-410n (e.g., instances of segments 210a-210n of FIG. 2) (also referred to as local segments). Segments 410a-410n run on segments hosts, though the segment hosts are not shown for ease of illustration. Similarly, the remote cluster 451 includes remote coordinator 454 (e.g., an instance of coordinator 204 of FIG. 2) and segments 460a-460n (e.g., instances of segments 210a-210n of FIG. 2) (also referred to as remote segments). Segments 460a-460n run on segments hosts, though the segment hosts are not shown for ease of illustration.

Local coordinator 404 has created thereon an extension, foreign data wrapper extension 412, which may be a PostgreSQL extension. Foreign data wrapper extension 412 is a module that allows local coordinator 404 to setup foreign data wrappers on local coordinator 404 and segments 410a-410n. A foreign data wrapper is a library that allows for communication with external data sources, and hides the details for connecting to an external data source and obtaining data from the external data source. In certain aspects, the foreign data wrapper is a PostgreSQL foreign data wrapper. In certain aspects, a foreign data wrapper includes information for accessing an external data source, such as address information (e.g., IP address of the data source), username/password for login, etc.

Remote coordinator 454 has created thereon an extension, parallel retrieve cursor extension 464, which may be a PostgreSQL extension. Parallel retrieve cursor extension 464 is a module that allows remote coordinator 454 to setup cursors on remote coordinator 454 and/or segments 460a-460n. A cursor, in the context of databases, is a mechanism (e.g., data structure and/or process) that enables traversal over records in the table(s) of the database. Cursors facilitate subsequent processing in conjunction with the traversal, such as retrieval, addition, and removal of database records. In certain aspects, a cursor can be viewed as a pointer to a row in a set of rows (e.g., of a table).

Local coordinator 404 has created thereon a foreign data wrapper 416 (a foreign data wrapper server), and, in some cases, remote coordinator 454 has created thereon a corresponding foreign data wrapper remote process 466. In certain aspects, local coordinator 404 can communicate with remote coordinator 454 using foreign data wrapper 416. Further, foreign data wrapper remote process 466 may facilitate performing foreign data wrapper functions remotely at remote coordinator 454.

Remote coordinator 454 further has stored thereon remote ordinary table 468, which may be a PostgreSQL table. Remote ordinary table 468 may store the metadata indicating where data is stored in remote cluster 451, such as in which segment 460, on which segment host, and/or the like, as discussed. For example, the metadata may be stored in the form of a table. Though not shown, local coordinator 404 may similarly have stored therein a local ordinary table that stores metadata indicating where data is stored in local cluster 401.

Local coordinator 404 further has stored thereon foreign table 418, which may be a PostgreSQL foreign table. A foreign table can be used in queries just like a normal table, but a foreign table has no storage. Accordingly, no data is stored in foreign table 418. Rather, foreign table 418 is bound to remote ordinary table 468. Thus, local coordinator 404 can access foreign table 418 to access remote ordinary table 468. Based on accessing foreign table 418, therefore, local coordinator 404 can determine which segments 460 of remote cluster 451 may store data responsive to a query. In certain aspects, whenever access is made, such as by local coordinator 404, to foreign table 418, foreign data wrapper 416 fetches or transmits the data from or to remote ordinary table 468.

Each segment 410a-410n has created thereon a corresponding foreign data wrapper 420a-420n (a foreign data wrapper server). Further, each segment 460a-460n has created thereon a corresponding foreign data wrapper remote process 470a-470n. In certain aspects, each segment 410a-410n can communicate with a corresponding segment 460a-460n via the corresponding foreign data wrapper 420 and foreign data wrapper remote process 470. For example, foreign data wrapper 420a may be configured to communicate with foreign data wrapper remote process 470a, such that segment 410a can communicate with segment 460a. In another example, foreign data wrapper 420b may be configured to communicate with foreign data wrapper remote process 470b, such that segment 410b can communicate with segment 460b.

In certain aspects, the number of segments 410 in local cluster 401 may be different than the number of segments 460 in remote cluster 451. Where there are more segments 410 than segments 460, one or more segments 410 may not communicate with a segment 460 as discussed herein to retrieve data. Where there are less segments 410 than segments 460, a given segment 410 may communicate with multiple segments 460 as discussed herein to retrieve data.

Each segment 460a-460n includes a corresponding remote table 472a-472n. The remote table 472 of a given segment 460 stores the data of the given segment. Though not shown, each segment 410 may similarly have stored therein a local table that stores data of the segment 410.

Each segment 460a-460n further includes a corresponding endpoint 474a-474n. In certain aspects, an endpoint 474 stores data responsive to a query and can be accessed by a segment 410, such that a segment 410 can directly retrieve data responsive to a query from a segment 460 directly, without having to retrieve that data via remote coordinator 454 and local coordinator 404. Therefore, retrieval of query data by local cluster 401 from remote cluster 451 can be parallelized across segments 410, thereby reducing latency for processing the query.

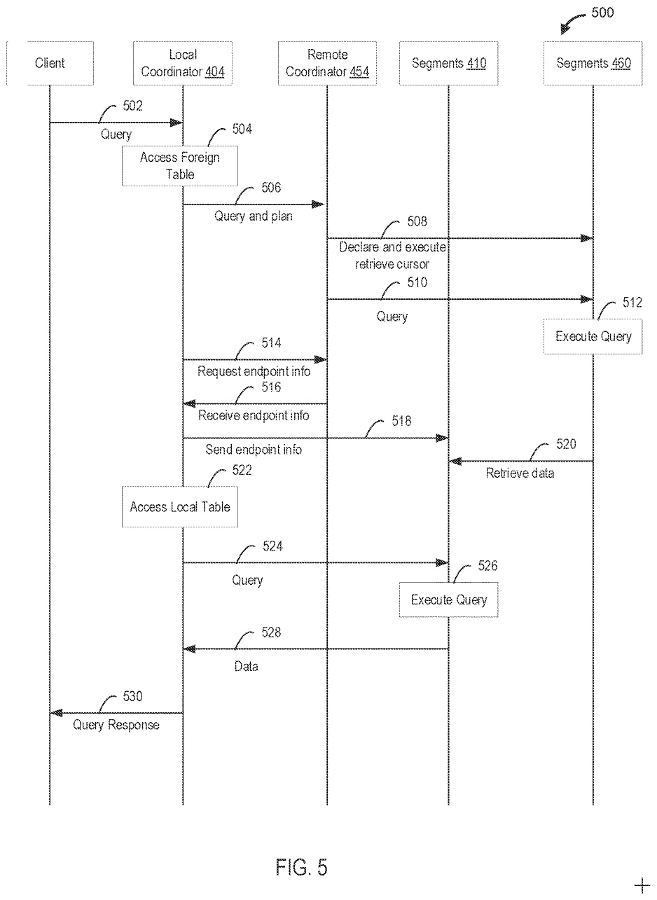

FIG. 5 shows a call flow diagram depicting a method for operating the federated query processing system of FIG. 4.

At 502, local coordinator 404 receives a query from a client. At 504, local coordinator 404 accesses foreign table 418 to access remote ordinary table 468 via foreign data wrapper 416 to determine which segments 460 include data responsive to the query. At 506, local coordinator 404 sends the query to remote coordinator 454, along with an indication (e.g., a plan) of which segments 460 include data responsive to the query.

At 508, remote coordinator 454, using parallel retrieve cursor extension 464, declares and executes a parallel retrieve cursor on remote coordinator 454, which causes remote coordinator 454 to declare and execute a retrieve cursor on each segment 460 (e.g., each segment 460 with data responsive to the query). Accordingly, there are parallel retrieve cursors on segments 460, allowing queries to be run in parallel across segments 460. At 510, remote coordinator 454 dispatches (e.g., sends) the query to each segment 460 with data responsive to the query to execute the query.

At 512, at each segment 460 that receives the query, the segment 460 executes the query to retrieve data responsive to the query (e.g., using the retrieve cursor of the segment 460), but instead of sending the response to remote coordinator 454, each segment stores the data responsive to the query in a corresponding endpoint 474.

At 514, local coordinator 404 sends a message to remote coordinator 454 requesting information about endpoints 474 associated with segments 460 including data responsive to the query. The information for an endpoint 474 may include information to access the endpoint 474, such as an address (e.g., IP address), token number, status, hostname, port, and/or the like. At 516, remote coordinator 454 sends the information about endpoints 474 to local coordinator 404.

At 518, local coordinator 404 sends information about endpoints 474 to segments 410. For example, local coordinator 404 sends information about a corresponding endpoint 474 to each segments 410, such as information about endpoint 474a to segment 410a, information about endpoint 474b to segment 410b, etc. In certain aspects, as discussed, a segment 410 may not be sent any information about an endpoint 474, or may be send information about multiple endpoints 474.

At 520, each segment 410 connects to the corresponding endpoint(s) 474 for which it receives information, on the corresponding segment(s) 460, such as via corresponding foreign data wrapper 420 and foreign data wrapper(s) 470, and retrieves the data responsive to the query from the endpoint(s) 474.

Optionally, at 522, local coordinator 404 accesses a local table to determine which segments 410 include data responsive to the query. Optionally, at 524, local coordinator 404 dispatches (e.g., sends) the query to each segment 410 with data responsive to the query to execute the query. Optionally, at 526, at each segment 410 that receives the query, the segment 410 executes the query to retrieve data responsive to the query.

At 528, each segment 410 sends to local coordinator 404 data responsive to the query, including data retrieved from a corresponding segment 460, and optionally, data retrieved locally at the segment 410.

At 530, local coordinator 404 sends the data received from each segment 410 as a response to the query to the client. In certain aspects, the local coordinator 404 further processes the data received from each segment 410 to generate the response to the query.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more non-transitory computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers”. OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for querying data across a plurality of distributed databases, comprising:
receiving a query at a local coordinator of a local database cluster;
sending the query to a remote coordinator of a remote database cluster;
retrieving, by each local segment of a plurality of local segments of the local database cluster, data responsive to the query from corresponding one or more remote segments of the remote database cluster associated with the local segment; and
sending a response to the query based on the data responsive to the query from each of the corresponding one or more remote segments.

2. The method of claim 1, wherein the retrieving, by each local segment of the plurality of local segments, data responsive to the query comprises:
connecting to the one or more remote segments associated with the local segment by a foreign data wrapper running on the local segment and one or more foreign data wrapper remote processes running on the one or more remote segments.

3. The method of claim 1, further comprising:
determining, by the local coordinator, which remote segments of the remote database cluster include data responsive to the query based on accessing a foreign table at the local coordinator that is bound to a remote ordinary table at the remote coordinator.

4. The method of claim 1, further comprising:
sending the query from the remote coordinator to remote segments of the remote database cluster that include data responsive to the query; and
executing the query at each of the remote segments of the remote database cluster that include data responsive to the query.

5. The method of claim 4, further comprising:
declaring and executing parallel retrieve cursors on the remote segments of the remote database cluster that include data responsive to the query, wherein executing the query comprises using the parallel retrieve cursors.

6. The method of claim 4, further comprising:
storing data responsive to the query in a corresponding endpoint of each of the remote segments of the remote database cluster that include data responsive to the query, wherein the retrieving is from each corresponding endpoint.

7. The method of claim 1, further comprising:
executing, by each local segment of the plurality of local segments, the query to retrieve data responsive to the query, wherein the response to the query is further based on the data responsive to the query from each of the plurality of local segments.

8. One or more non-transitory computer-readable media comprising instructions, which when executed by one or more processors of a computer system, cause the computer system to perform operations for querying data across a plurality of distributed databases, the operations comprising:
receiving a query at a local coordinator of a local database cluster;
sending the query to a remote coordinator of a remote database cluster;
retrieving, by each local segment of a plurality of local segments of the local database cluster, data responsive to the query from corresponding one or more remote segments of the remote database cluster associated with the local segment; and
sending a response to the query based on the data responsive to the query from each of the corresponding one or more remote segments.

9. The one or more non-transitory computer-readable media of claim 8, wherein the retrieving, by each local segment of the plurality of local segments, data responsive to the query comprises:
connecting to the one or more remote segments associated with the local segment by a foreign data wrapper running on the local segment and one or more foreign data wrapper remote processes running on the one or more remote segments.

10. The one or more non-transitory computer-readable media of claim 8, wherein the operations further comprise:
determining, by the local coordinator, which remote segments of the remote database cluster include data responsive to the query based on accessing a foreign table at the local coordinator that is bound to a remote ordinary table at the remote coordinator.

11. The one or more non-transitory computer-readable media of claim 8, wherein the operations further comprise:
sending the query from the remote coordinator to remote segments of the remote database cluster that include data responsive to the query; and
executing the query at each of the remote segments of the remote database cluster that include data responsive to the query.

12. The one or more non-transitory computer-readable media of claim 11, wherein the operations further comprise:
declaring and executing parallel retrieve cursors on the remote segments of the remote database cluster that include data responsive to the query, wherein executing the query comprises using the parallel retrieve cursors.

13. The one or more non-transitory computer-readable media of claim 11, wherein the operations further comprise:
storing data responsive to the query in a corresponding endpoint of each of the remote segments of the remote database cluster that include data responsive to the query, wherein the retrieving is from each corresponding endpoint.

14. The one or more non-transitory computer-readable media of claim 8, wherein the operations further comprise:
executing, by each local segment of the plurality of local segments, the query to retrieve data responsive to the query, wherein the response to the query is further based on the data responsive to the query from each of the plurality of local segments.

15. A computer system comprising: one or more memories and one or more processors configured to perform operations for querying data across a plurality of distributed databases, the operations comprising:
receiving a query at a local coordinator of a local database cluster;
sending the query to a remote coordinator of a remote database cluster;
retrieving, by each local segment of a plurality of local segments of the local database cluster, data responsive to the query from corresponding one or more remote segments of the remote database cluster associated with the local segment; and
sending a response to the query based on the data responsive to the query from each of the corresponding one or more remote segments.

16. The computer system of claim 15, wherein the retrieving, by each local segment of the plurality of local segments, data responsive to the query comprises:
connecting to the one or more remote segments associated with the local segment by a foreign data wrapper running on the local segment and one or more foreign data wrapper remote processes running on the one or more remote segments.

17. The computer system of claim 15, wherein the operations further comprise:
determining, by the local coordinator, which remote segments of the remote database cluster include data responsive to the query based on accessing a foreign table at the local coordinator that is bound to a remote ordinary table at the remote coordinator.

18. The computer system of claim 15, wherein the operations further comprise:
sending the query from the remote coordinator to remote segments of the remote database cluster that include data responsive to the query; and
executing the query at each of the remote segments of the remote database cluster that include data responsive to the query.

19. The computer system of claim 18, wherein the operations further comprise:
declaring and executing parallel retrieve cursors on the remote segments of the remote database cluster that include data responsive to the query, wherein executing the query comprises using the parallel retrieve cursors.

20. The computer system of claim 18, wherein the operations further comprise:
storing data responsive to the query in a corresponding endpoint of each of the remote segments of the remote database cluster that include data responsive to the query, wherein the retrieving is from each corresponding endpoint.
